(19) United States
(12) Patent Application Publication
(10) Pub. No.: US 2025/0373985 A1
(43) Pub. Date: Dec. 4, 2025

(54) Loudspeaker

(71) Applicant: Harman International Industries, Incorporated, Stamford, CT (US)

(72) Inventors: Zhenjin ZHU, Shenzhen (CN); Yadi WANG, Shenzhen (CN); Jihui ZENG, Shenzhen (CN); Jinquan HUANG, Shenzhen (CN)

(73) Assignee: Harman International Industries, Incorporated, Stamford, CT (US)

(21) Appl. No.: 19/220,076

(22) Filed: May 27, 2025

(30) Foreign Application Priority Data
May 28, 2024 (CN) 2024106745806

(51) Int. Cl. H04R 9/02; H04R 9/06; H04R 31/00

(52) U.S. Cl. CPC H04R 9/025; H04R 9/06; H04R 31/006; H04R 2400/11

(57) ABSTRACT

The present disclosure relates to a loudspeaker, which has an cover, a diaphragm, a voice coil and a magnetic circuit system, wherein the magnetic circuit system includes: a top plate having a first hole, a magnet having a second hole, a yoke having a third hole, wherein the top plate, the magnet and the yoke are arranged in sequence and the first hole, the second hole and the third hole are aligned, a frame, wherein the frame surrounds the yoke in contact and fixes the yoke, and the frame has a strut and a flange connected to the strut, wherein the strut passes through the aligned first hole, second hole and third hole, and the flange is attached to the top plate, wherein the frame, the strut and the flange are integrated.

### CROSS REFERENCE

Priority is claimed to application No. 202410674580.6, filed May 28, 2024, in China, the disclosure of which is incorporated in its entirety by reference.

### TECHNICAL FIELD

The present disclosure relates to a loudspeaker.

### BACKGROUND

In a loudspeaker of the prior art, a top plate, a magnet, and a yoke (or U-iron) are bonded together through glue, and the yoke is also bonded to the frame through glue, so a large volume of glue is used, which is not environmentally friendly. There are also attempts in the prior art to reduce the use of glue, for example, there is a central opening and a fixing piece is used instead of glue bonding. However, these technologies still use a large number of parts, and there is still room for improvement in the manufacturing process. The complexity of manufacturing tools still needs to be reduced, the manufacturing process still needs to be simplified, and the manufacturing efficiency still needs to be improved.

In addition, electronic products are gradually developing in the direction of low cost and high performance, and the same requirements are placed on loudspeakers. For example, the loudspeaker is required to have integrated parts while having good acoustic performance; the loudspeaker is required to have good reliability; the loudspeaker is required to have a lower material cost; and the loudspeaker is required to have a lower market price.

### SUMMARY OF THE INVENTION

The present disclosure is directed to overcoming at least some of the above-mentioned problems in the prior art.

In order to solve the technical problem, the present disclosure provides a loudspeaker having a cover, a diaphragm, a voice coil, and a magnetic circuit system, wherein the magnetic circuit system comprises:
a top plate having a first hole,
a magnet having a second hole,
a yoke having a third hole, wherein the top plate, the magnet and the yoke are arranged in sequence and the first hole, the second hole and the third hole are aligned,
a frame, the frame surrounds the yoke in contact and fixes the yoke, and the frame has a strut and a flange connected to the strut, wherein the strut passes through the aligned first hole, second hole and third hole, and the flange is attached to the top plate, wherein the frame, the strut and the flange are integrated.

According to one or more embodiments of the present disclosure, the cross section of the yoke has a U-shape, wherein the yoke has a groove at an edge, and the frame surrounds the yoke in contact, wherein the frame has a shoulder, wherein the shoulder is connected to the groove in a form-fitting manner.

According to one or more embodiments of the present disclosure, the cover surrounds the diaphragm, wherein the cover is fixed to the frame.

According to one or more embodiments of the present disclosure, the first hole, the second hole, and the third hole are all central holes.

According to one or more embodiments of the present disclosure, the top plate has a plurality of first holes, the magnet has a plurality of second holes, and the yoke has a plurality of third holes, and the plurality of first holes, second holes, and third holes are respectively aligned with each other.

According to one or more embodiments of the present disclosure, a separate sleeve is arranged in the first hole, the second hole, and the third hole, and the sleeve has an outer diameter equal to the inner diameters of the first hole, the second hole, and the third hole.

According to one or more embodiments of the present disclosure, the frame, the strut, and the flange are an integrally formed injection molded part.

In order to solve the technical problem, the present disclosure also provides a method for manufacturing a loudspeaker comprising a cover, a diaphragm, a voice coil and a magnetic circuit system, wherein the magnetic circuit system comprises a top plate having a first hole, a magnet having a second hole, and a yoke having a third hole, the method comprising the following steps of:
a first step: stacking the top plate, the magnet and the yoke in sequence and aligning the first hole, the second hole and the third hole;
a second step: arranging the top plate, the magnet, and the yoke in the mold;
a third step: forming an integrated frame by injection molding, so that the frame surrounds the yoke in contact and fixes the yoke, and so that the frame has a strut and a flange connected to the strut, wherein the strut passes through the aligned first hole, second hole and third hole, and the flange is attached to the top plate.

According to one or more embodiments of the present disclosure, the method comprises:
a fourth step after the first step: inserting a sleeve into the first hole, the second hole, and the third hole, wherein the sleeve has an outer diameter equal to the inner diameters of the first hole, the second hole, and the third hole,
a fifth step: arranging the top plate, the magnet, the yoke, and the sleeve in the mold;
wherein the third step is performed after the fifth step.

According to one or more embodiments of the present disclosure, the method includes:
a sixth step: bonding the diaphragm and the voice coil through glue, and the diaphragm and the voice coil form a vibration system;
a seventh step: magnetizing the magnetic circuit system through a magnetizing machine;
an eighth step: bonding the vibration system and the magnetic circuit system through glue.

According to one or more embodiments of the present disclosure, the sixth step is performed prior to the first step, or the sixth step is performed in parallel with the first step in time.

### DESCRIPTION OF THE DRAWINGS

In order to more clearly illustrate the technical solutions of the embodiments of the present disclosure, the drawings of the embodiments will be briefly introduced below. Apparently, the drawings in the following description only relate to some embodiments of the present disclosure, rather than limiting the present disclosure.

FIG. 1 schematically illustrates a cross-sectional view of a loudspeaker according to one or more embodiments of the present disclosure;

FIG. 2 schematically illustrates an exploded view of a magnetic circuit system according to the present disclosure;

FIG. 3 illustrates a force factor simulation curve;

FIG. 4 schematically illustrates a cross-sectional view of a loudspeaker according to one or more embodiments of the present disclosure; and

FIG. 5 illustrates a flow chart of a method for manufacturing a loudspeaker according to the present disclosure.

### DETAILED DESCRIPTION

Embodiments of the present invention will be described in detail below. Examples of the embodiments are shown in the accompanying drawings, wherein the same or similar reference numerals always indicate the same or similar elements or elements with the same or similar functions. The embodiments described below with reference to the accompanying drawings are illustrative, which are only used to explain the present invention, and cannot be construed as limitations to the present invention.

Unless otherwise defined, the technical terms or scientific terms used here should have the ordinary meanings understood by those of ordinary skill in the field of the present invention. In the description of the present invention, it should be understood that an orientation or positional relationship indicated by the terms “center,” “longitudinal,” “lateral,” “upper,” “lower,” “front,” “back,” “left,” “right,” “vertical,” “horizontal,” “top,” “bottom,” “inner,” “outer,” etc. is an orientation or positional relationship shown based on the accompanying drawings, is only for the convenience of describing the present invention and simplifying the description, rather than indicating or implying that a device or element referred to must have a specific orientation or be constructed and operated in a specific orientation, and thus cannot be understood as a limitation to the present invention. In addition, the terms “first” and “second” are only used for descriptive purposes, and cannot be understood as indicating or implying relative importance.

The present disclosure relates to a loudspeaker having a cover, a diaphragm, a voice coil, and a magnetic circuit system, wherein the magnetic circuit system comprises:
a top plate having a first hole,
a magnet having a second hole,
a yoke having a third hole, wherein the top plate, the magnet and the yoke are arranged in sequence and the first hole, the second hole and the third hole are aligned,
a frame, the frame surrounds the yoke in contact and fixes the yoke, and the frame has a strut and a flange connected to the strut, wherein the strut passes through the aligned first hole, second hole and third hole, and the flange is attached to the top plate, wherein the frame, the strut and the flange are integrated.

The present invention solves many technical problems in the prior art through an integrated frame. Firstly, the top plate, the magnet and the yoke are held between the flange and the frame. In other words, the frame stably fixes the top plate, the magnet and the yoke with the help of the struts and the flange, thereby eliminating the need for glue between the top plate and the magnet, between the magnet and the yoke, and between the yoke and the frame, which not only saves costs but also makes the manufacturing process more environmentally friendly. There is no need to set additional fixing devices between the top plate, magnet, and yoke, thereby reducing the number of parts, reducing the assembly process of the fixing devices, and saving manpower and time.

In addition, the frame in the present disclosure completely surrounds and fixes the yoke, thereby fixing the entire magnetic circuit system, and the frame in the present disclosure also fixes the cover, so the frame integrates multiple functions through one part, reduces the number of parts, and ensures shape stability.

In addition, the openings of the top plate, the magnet and the yoke of the present disclosure can be arranged at their respective centers and are not necessarily limited to a central position, nor do they need to be limited to a number of one, so there can be multiple openings, which increases the flexibility of design.

In addition, in the present disclosure, a separate sleeve is arranged in the first, second, and third holes, which has the same outer diameter as the inner diameters of the first, second, and third holes. Here, the sleeve functions as a positioning sleeve, which ensures that the top plate, the magnet, and the yoke are perfectly aligned during the manufacturing process, increases the accuracy of the fit between the parts, and the sleeve can provide additional stability. In addition, the sleeve can also simplify the design of the mold, which will be explained in detail below.

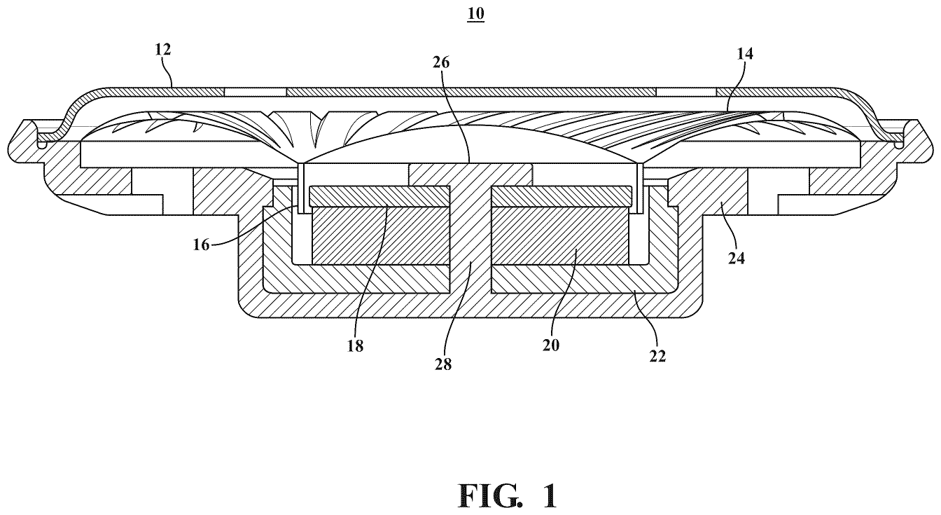

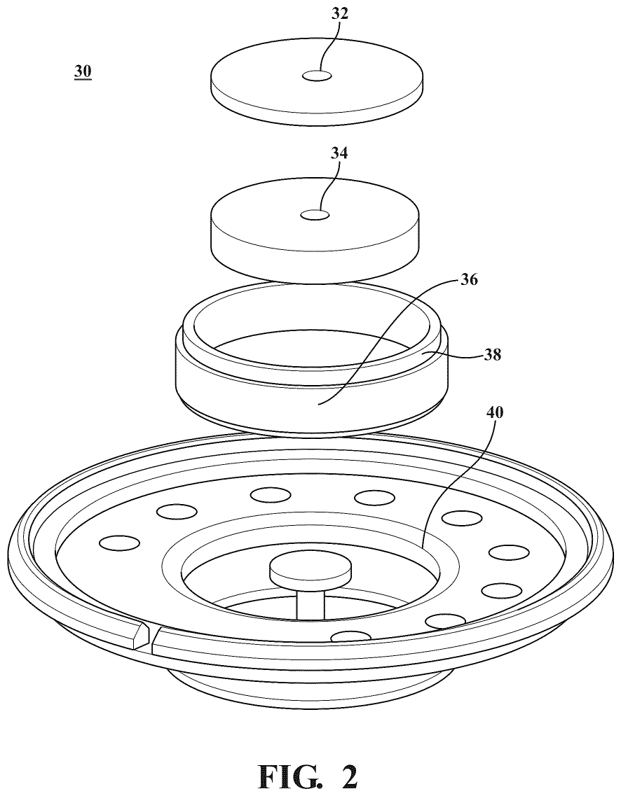

The features of the present invention are shown as a whole in FIGS. 1 to 5, which involve: a loudspeaker 10, a cover 12, a diaphragm 14, a voice coil 16, a top plate 18, a magnet 20, a yoke 22, a frame 24, a flange 26, a strut 28, a magnetic circuit system 30, a first hole 32, a second hole 34, a third hole 36 (the location of which is identified in FIG. 2, but the third hole itself is not visible in the figure), a groove 38, a shoulder 40, a sleeve 42, a first step 102, a second step 104, a third step 106, a fourth step 202, a fifth step 204, a sixth step 108, a seventh step 110, and an eighth step 112.

FIG. 1 schematically illustrates a cross-sectional view of a loudspeaker 10 according to one or more embodiments of the present disclosure. FIG. 2 schematically illustrates an exploded view of a magnetic circuit system 30 according to the present disclosure. One or more embodiments are described in combination with FIGS. 1 and 2, wherein the loudspeaker 10 has a cover 12, a diaphragm 14, a voice coil 16 and a magnetic circuit system 30. As shown in FIG. 2, the magnetic circuit system 30 includes: a top plate 18 having a first hole 32, a magnet 20 having a second hole 34, and a yoke 22 having a third hole 36, wherein the top plate 18, the magnet 20 and the yoke 22 are arranged in sequence and the first hole 32, the second hole 34 and the third hole 36 are aligned. And the yoke 22 is supported in a frame 24. As shown in FIG. 1, the frame 24 has a strut 28 and a flange 26 connected to the strut 28, wherein the flange 26 is attached to the top plate 18, so that the flange 26 and the bottom of the frame 24 fix the top plate 18, the magnet 20 and the yoke 22 in the axial direction. Furthermore, the strut 28 and the frame 24 also ensure that the top plate 18, the magnet 20 and the yoke 22 will not be displaced laterally. It can be seen from the cross-sectional view of FIG. 1 that the flange 26, the strut 28 and the frame 24 are integral, or in other words, integrally formed. There are many ways to form the mold, such as injection molding, 3D printing, etc. Here, injection molding is advantageous from the perspective of manufacturing process and cost.

The voice coil 16 and the diaphragm 14 are fixedly connected, for example, through gluing or other fixing methods. The voice coil 16 is arranged in the magnetic circuit system 30, more specifically, between the yoke 22 and the magnet 20. Furthermore, FIG. 1 shows that the cover 12 surrounds the diaphragm 14, and the cover 12 is fixed to the frame 24, for example, fixed in an annular groove on the outer periphery of the frame 24.

It can also be seen from FIG. 1 that the cross-section of the yoke 22 has a U-shape, wherein the yoke 22 has a groove 38 at an edge, that is, the yoke 22 has a radially outward groove 38 at the upper edge, and accordingly, the frame 24 has a shoulder 40, wherein the shoulder 40 is connected to the groove 38 in a form-fitting manner, thereby stably fixing the yoke 22. Furthermore, the frame 24 surrounds the yoke 22 in contact. As can be seen from FIG. 1, the frame 24 also has a U-shape that matches the yoke 22, so that the frame 24 can completely enclose the yoke 22 and provide stable fixation. And the frame 24 has a flat bottom which fits the yoke 22 without any gap therebetween. A strut 28 is arranged at the center of the bottom, and the flange 26 is connected to the strut 28. As shown in the figure, the flange 26 has a disc shape, so the flange 26 is attached to the top plate 18. Alternatively, the flange 26 has a dome-like shape, or a bolt head shape, etc., which can be selected according to an existing mold. In general, the frame 24 may have a rotationally symmetrical structure. However, the present disclosure is not limited thereto, and the shape of the frame 24 may also be square, racetrack, or elliptical, and accordingly, the magnetic circuit system 30 may also have a shape that matches the shape.

In FIG. 1 and FIG. 2, the first hole 32, the second hole 34, and the third hole 36 are all central holes. However, in an embodiment not shown, the top plate 18 has a plurality of first holes 32, the magnet 20 has a plurality of second holes 34, and the yoke 22 has a plurality of third holes 36, and the plurality of first holes 32, second holes 34 and third holes 36 are respectively aligned with each other. For example, the top plate 18, the magnet 20, and the yoke 22 have two holes, three holes, or four holes, respectively, which can meet different product designs.

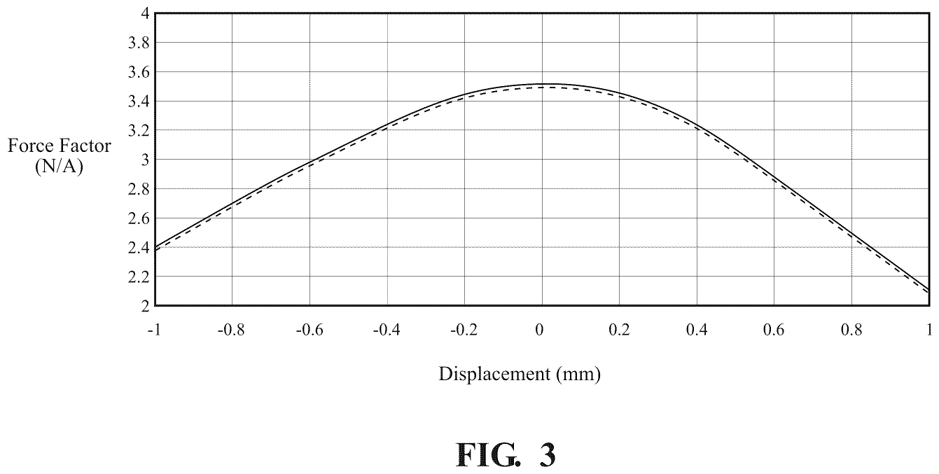

FIG. 3 illustrates a force factor simulation curve (or referred to as a BL (x) simulation curve), wherein the abscissa represents the displacement of the diaphragm 14 in mm, i.e., millimeters, and the ordinate represents the force factor in N/A, i.e., Newton/ampere. The solid line represents a force factor simulation curve of a conventional magnetic circuit system 30, for example, the top plate 18, the magnet 20 and the yoke 22 are bonded to each other through glue, and the dotted line represents a force factor simulation curve of one or more embodiments of the present disclosure. The comparison results show that the force factor of the magnetic circuit system 30 of the present invention is 0.017 N/A lower than that of the traditional magnetic circuit system 30, so the impact on the overall performance of the loudspeaker 10 can be ignored.

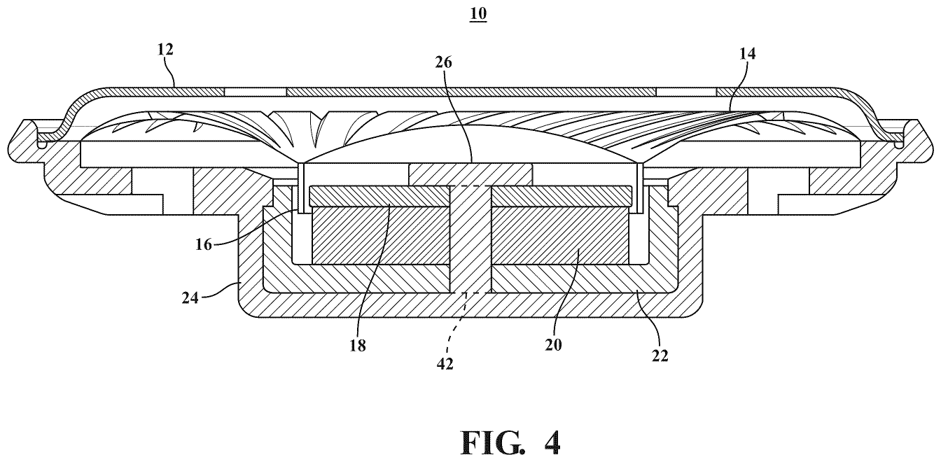

FIG. 4 schematically illustrates a cross-sectional view of a loudspeaker 10 according to one or more embodiments of the present disclosure, and only the differences from one or more embodiments are described herein, namely, a separate sleeve 42 is arranged in the first hole 32, the second hole 34 and the third hole 36, and the sleeve 42 has an outer diameter equal to the inner diameters of the first hole 32, the second hole 34 and the third hole 36. The separate sleeve 42 is not integral with the frame 24, and the sleeve 42 can be regarded as a positioning device and a reinforcement device. Because during the injection molding process, the top plate 18, the magnet 20 and the yoke 22 need to be arranged in the mold, and in this case the mold needs to have a centering device to align the holes of the three parts. The centering device needs to be inserted into the radial gap between the yoke 22 and the magnet 20. However, there is a manufacturing tolerance between the centering device and the magnet 20 and the top plate 18. Especially after a long period of use, it is difficult to ensure the precise alignment of the top plate 18, the magnet 20 and the yoke 22. Therefore, when a separate sleeve 42 is arranged in the first hole 32, the second hole 34, and the third hole 36, the sleeve 42 can always ensure accurate alignment of the top plate 18, the magnet 20, and the yoke 22, and a centering device for the mold can be eliminated. In addition, after the frame 24 is formed, the sleeve 42 can be retained in the frame 24, thereby providing a certain strength and ensuring that the top plate 18, the magnet 20 and the yoke 22 are in the theoretical design position, thereby ensuring that the actual magnetic field is more consistent with the theoretical design magnetic field.

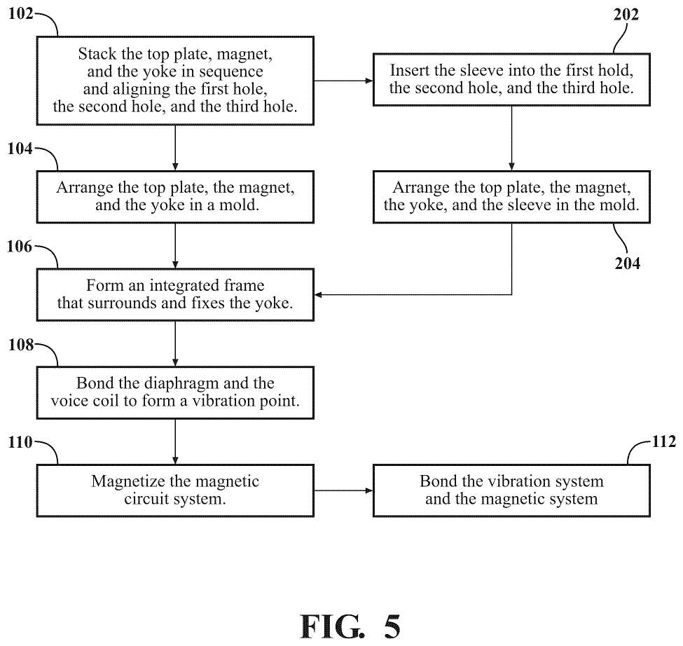

FIG. 5 illustrates a flow chart of a method for manufacturing a loudspeaker 10 according to the present disclosure. Here, the loudspeaker 10 includes a cover 12, a diaphragm 14, a voice coil 16, and a magnetic circuit system 30. The magnetic circuit system 30 includes a top plate 18 having a first hole 32, a magnet 20 having a second hole 34, and a yoke 22 having a third hole 36. The method comprises the following steps: a first step 102: stacking the top plate 18, the magnet 20 and the yoke 22 in sequence and aligning the first hole 32, the second hole 34 and the third hole 36; a second step 104: arranging the top plate 18, the magnet 20 and the yoke 22 in a mold; a third step 106: forming an integrated frame 24 by injection molding, so that the frame 24 surrounds the yoke 22 in contact and fixes the yoke 22, and so that the frame 24 has a strut 28 and a flange 26 connected to the strut 28, wherein the strut 28 passes through the aligned first hole 32, the second hole 34 and the third hole 36, and the flange 26 is attached to the top plate 18.

Through the method in the present disclosure, the process of gluing can be omitted, thereby eliminating the corresponding equipment and manpower. In particular, the positioning jigs and assembly jigs originally used to position these parts are eliminated. At the same time, it also saves the manpower input at the workstations during the production process of the loudspeaker 10, reduces the original drying time of the glue baking, improves production efficiency, and reduces costs.

As shown in FIG. 5, the sleeve 42 may also be provided after the first step 102 is completed, that is, the method includes a fourth step 202: inserting the sleeve 42 into the first hole 32, the second hole 34 and the third hole 36, wherein the sleeve 42 has an outer diameter equal to the inner diameters of the first hole 32, the second hole 34 and the third hole 36, a fifth step 204: arranging the top plate 18, the magnet 20, the yoke 22 and the sleeve 42 in the mold, and performing the third step 106 after the fifth step 204. Here, the fifth step 204 can be regarded as a replacement for the second step 104, and of course can also be regarded as a supplement to the second step 104, and therefore needs to conform to the actual manufacturing process. Through this method, the positioning between the top plate 18, the magnet 20, and the yoke 22 is very precise, and there is no need to specially design the mold, especially there is no need to provide a centering device or an alignment device for the top plate 18, the magnet 20, and the yoke 22. Moreover, the use of the sleeve 42 basically does not affect the injection molding of the strut 28, because the sleeve 42 is hollow and has only a very thin wall, so there is space in the center for the strut 28. Therefore, by using a simple sleeve 42, the positioning between the various parts can be improved, and the stability can still be ensured after the frame 24 is formed.

As shown in FIG. 5, after the third step 106, the sixth step 108 is performed: bonding the diaphragm 14 and the voice coil 16 through glue, and the diaphragm 14 and the voice coil 16 form a vibration system, the seventh step 110: magnetizing the magnetic circuit system 30 through a magnetizing machine, and the eighth step 112: bonding the vibration system and the magnetic circuit system 30 through glue, and fixing the cover 12 on the frame 24.

Since the bonding between the diaphragm 14 and the voice coil 16 through glue is very efficient, and the glue used here is less than 10% of the glue used in the traditional loudspeaker 10, the sixth step 108 can still be carried out in this way. Through the sixth step 108, the diaphragm 14 and the voice coil 16 form a vibration system, which can be used as a whole in subsequent processes. In the eighth step 112, the vibration system and the magnetic circuit system 30 are bonded together through glue. The amount of glue used here is still much less than the amount of glue originally used in the magnetic circuit system 30, so glue can still be used as a fixing means. By fixing the cover 12 on the frame 24, the assembly of the entire loudspeaker 10 is completed.

Furthermore, the sixth step 108 is performed prior to the first step 102. Thus, the first step 102 can be performed while waiting for the glue to dry, thus saving a certain amount of time. Alternatively, the sixth step 108 and the first step 102 are performed in parallel in time, which is advantageous for continuous manufacturing and can improve production efficiency.

Through the method in the present disclosure, the entire manufacturing process is simplified, the number of parts is reduced, the production efficiency is improved, and the stability of the product is increased.

The present disclosure can be implemented in the following ways:

Item 1: A loudspeaker 10 comprising a cover 12, a diaphragm 14, a voice coil 16 and a magnetic circuit system 30, wherein the magnetic circuit system 30 comprises:
a top plate 18 having a first hole 32,
a magnet 20 having a second hole 34,
a yoke 22 having a third hole 36, wherein the top plate 18, the magnet 20 and the yoke 22 are arranged in sequence and the first hole 32, the second hole 34 and the third hole 36 are aligned,
a frame 24, the frame 24 surrounds the yoke 22 in contact and fixes the yoke 22, and the frame 24 has a strut 28 and a flange 26 connected to the strut 28, wherein the strut 28 passes through the aligned first hole 32, second hole 34 and third hole 36, and the flange 26 is attached to the top plate 18, wherein the frame 24, the strut 28 and the flange 26 are integrated.

Item 2: The loudspeaker 10 of Item 1, the cross section of the yoke 22 has a U-shape, wherein the yoke 22 has a groove 38 at an edge, and the frame 24 has a shoulder 40, wherein the shoulder 40 is connected to the groove 38 in a form-fitting manner.

Item 3: The loudspeaker 10 of Item 1 or 2, the cover 12 surrounds the diaphragm 14, wherein the cover 12 is fixed to the frame 24.

Item 4: The loudspeaker 10 of any one of Items 1 to 3, the first hole 32, the second hole 34, and the third hole 36 are all central holes.

Item 5: The loudspeaker 10 of any one of Items 1 to 4, the top plate 18 has a plurality of first holes 32, the magnet 20 has a plurality of second holes 34, the yoke 22 has a plurality of third holes 36, and the plurality of first holes 32, second holes 34 and third holes 36 are respectively aligned with each other.

Item 6: The loudspeaker 10 of any one of Items 1 to 5, characterized in that a separate sleeve 42 is arranged in the first hole 32, the second hole 34, and the third hole 36, and the sleeve 42 has an outer diameter equal to the inner diameters of the first hole 32, the second hole 34, and the third hole 36.

Item 7: The loudspeaker 10 of any one of Items 1 to 6, characterized in that the frame 24, the strut 28 and the flange 26 are an integrally formed injection molded part.

Item 8: A method for manufacturing a loudspeaker 10 comprising a cover 12, a diaphragm 14, a voice coil 16, and a magnetic circuit system 30, wherein the magnetic circuit system 30 comprises a top plate 18 having a first hole 32, a magnet 20 having a second hole 34, and a yoke 22 having a third hole 36, the method comprising steps of:
a first step 102: stacking the top plate 18, the magnet 20 and the yoke 22 in sequence and aligning the first hole 32, the second hole 34 and the third hole 36;
a second step 104: arranging the top plate 18, the magnet 20 and the yoke 22 in the mold;
a third step 106: forming an integrated frame 24 by injection molding, so that the frame 24 surrounds the yoke 22 in contact and fixes the yoke 22, and so that the frame 24 has a strut 28 and a flange 26 connected to the strut 28, wherein the strut 28 passes through the aligned first hole 32, the second hole 34 and the third hole 36, and the flange 26 is attached to the top plate 18.

Item 9: The method of Item 8, comprising:
a fourth step 202 after the first step 102: inserting a sleeve 42 into the first hole 32, the second hole 34 and the third hole 36, wherein the sleeve 42 has an outer diameter equal to the inner diameters of the first hole 32, the second hole 34 and the third hole 36,
a fifth step 204: arranging the top plate 18, the magnet 20, the yoke 22 and the sleeve 42 in the mold;
wherein the third step 106 is performed after the fifth step 204.

Item 10: The method of Item 8 or 9, wherein the method comprises:
a sixth step 108: bonding the diaphragm 14 and the voice coil 16 through glue, and the diaphragm 14 and the voice coil 16 form a vibration system;
a seventh step 110: magnetizing the magnetic circuit system 30 through the magnetizing machine;
an eighth step 112: bonding the vibration system and the magnetic circuit system 30 through glue, and the cover 12 is fixed on the frame 24.

Item 11: The method of any one of Items 8 to 10, the sixth step 108 is performed prior to the first step 102, or the sixth step 108 is performed in parallel with the first step 102 in time.

The foregoing is a description of the present invention and should not be considered a limitation thereof. Although several exemplary embodiments of the present invention are described, it will be readily understood by those skilled in the art that many modifications can be made to the exemplary embodiments without departing from the novel teachings and advantages of the present invention. Accordingly, all such modifications are intended to be encompassed within the scope of the present invention as defined by the claims. It should be understood that the foregoing is a description of the present invention and should not be considered to be limited to the particular embodiments as disclosed, and that modifications to the disclosed embodiments, as well as other embodiments, are intended to be included within the scope of the appended claims.

1. A loudspeaker comprising a cover, a diaphragm, a voice coil, and a magnetic circuit system, wherein the magnetic circuit system comprises:
a top plate having a first hole;
a magnet having a second hole;
a yoke having a third hole, wherein the top plate, the magnet and the yoke are arranged in sequence and the first hole, the second hole and the third hole are aligned; and
a frame, the frame surrounds the yoke in contact and fixes the yoke, and the frame has a strut and a flange connected to the strut, wherein the strut passes through the aligned first hole, a second hole and a third hole, and the flange is attached to the top plate, wherein the frame, the strut and the flange are integrated.

2. The loudspeaker of claim 1, wherein a cross-section of the yoke has a U-shaped shape, wherein the yoke has a groove at an edge, and the frame has a shoulder, wherein the shoulder is connected to the groove in a form-fitting manner.

3. The loudspeaker of claim 1, wherein the cover surrounds the diaphragm, wherein the cover is fixed to the frame.

4. The loudspeaker of claim 1, wherein the first hole, the second hole, and the third hole are all central holes.

5. The loudspeaker of claim 1, wherein the top plate has a plurality of first holes, the magnet has a plurality of second holes, the yoke has a plurality of third holes, and the plurality of first holes, second holes, and third holes are respectively aligned with each other.

6. The loudspeaker of claim 1, wherein a separate sleeve is arranged in the first hole, the second hole and the third hole, the sleeve has an outer diameter equal to an inner diameter of the first hole, the second hole and the third hole.

7. The loudspeaker of claim 1, wherein the frame, strut and flange are an integrally formed injection molded part.

8. A method of manufacturing a loudspeaker comprising a cover, a diaphragm, a voice coil, and a magnetic circuit system, wherein the magnetic circuit system comprises a top plate having a first hole, a magnet having a second hole, a yoke having a third hole, the method comprising the steps of:
stacking the top plate, the magnet and the yoke in sequence and aligning the first hole, the second hole and the third hole;
arranging the top plate, the magnet and the yoke in a mold;
forming an integrated frame by injection molding, so that the frame surrounds the yoke in contact and fixes the yoke, and so that the frame has a strut and a flange connected to the strut, wherein the strut passes through the aligned first hole, the second hole and the third hole, and the flange is attached to the top plate.

9. The method of claim 8, wherein the method comprises:
after the step of stacking and before the step of arranging, inserting a sleeve into the first hole, the second hole and the third hole, wherein the sleeve has an outer diameter equal to an inner diameter of the first hole, the second hole and the third hole; and
wherein the step of forming an integrated frame is performed after the step of arranging.

10. The method of claim 8, wherein the method comprises:
bonding the diaphragm and the voice coil through glue, and the diaphragm and the voice coil form a vibration system;
magnetizing the magnetic circuit system through a magnetizing machine; and
bonding the vibration system and the magnetic circuit system by glue, and the cover is fixed on the frame.

11. The method of claim 10, wherein the step of bonding the diaphragm and the voice coil is performed prior to the step of stacking.

12. The method of claim 10 wherein the step of bonding the diaphragm and the voice coil is performed in parallel with the step of stacking.
